(19) United States
(12) Patent Application Publication
(10) Pub. No.: US 2007/0273282 A1
(43) Pub. Date: Nov. 29, 2007

(54) Optoelectronic device

(75) Inventors: Emil V. Radkov, Euclid, OH (US); Thomas F. Soules, Livermore, CA (US)

Correspondence Address: Scott A. McCollister;Fay, Sharpe, Fagan, Minnich & McKee, LLP, Seventh Floor, 1100 Superior Avenue, Cleveland, OH, 44114-2579, US

(73) Assignee: GELcore LLC

(21) Appl. No.: 11/440,931

(22) Filed: May 25, 2006

(51) Int. Cl. H01J 1/62; H01J 63/04

(52) U.S. Cl. 313/512

(57) ABSTRACT

The present invention provides an optoelectronic device comprising a light source, an encapsulant with Refractive Index n₁, and a phosphor with Refractive Index n₂ which is within the range of from about 0.85n₁, to about 1.15n₁. The present invention also provides a method of adjusting the Refractive Index nₓ of a phosphor which is higher than a predetermined value n₂. The method comprises partially or completely replacing one or more first element(s) in the phosphor with one or more second elements which typically have lower atomic weight than the first element(s). The phosphor is chemically stable and optically comparable with the encapsulant; and the optoelectronic device has gained technical merits such as increased light output efficiency, easy manufacturability, and cost-effectiveness, among others.

### BACKGROUND OF THE INVENTION

The present invention is related to an optoelectronic device and method thereof. More particularly, the present invention provides an optoelectronic device comprising a light source, an encapsulant, and a phosphor with encapsulant-matching refractive index. The present invention also provides a method of adjusting the refractive index of a phosphor to match that of an encapsulant.

An optoelectronic device such as a white light source that utilizes LEDs in its construction can have two basic configurations. In the so-called direct emissive LEDs, white light is generated by direct emission of different colored LEDs. Examples include a combination of a red LED, a green LED, and a blue LED, and a combination of a blue LED and a yellow LED. In another configuration, the so-called LED-excited phosphor-converted light sources (PC-LEDs), a single LED generates a beam in a narrow range of wavelengths, which beam impinges upon and excites a phosphor material which emits light of other colors so as to produce visible light. The phosphor can comprise a mixture or combination of distinct phosphor materials, and the light emitted by the phosphor can include a plurality of narrow emission lines distributed over the visible wavelength range such that the emitted light appears substantially white to the unaided human eye. For example, U.S. Pat. No. 5,813,752 (Singer) and U.S. Pat. No. 5,813,753 (Vriens) have disclosed a UV/blue LED-phosphor device with efficient conversion of UV/blue light to visible light.

An example of a PC-LED is a blue LED illuminating a phosphor that converts blue to both red and green wavelengths. A portion of the blue excitation light is not absorbed by the phosphor, and the residual blue excitation light is combined with the red and green light emitted by the phosphor. Another example of a PC-LED is an ultraviolet (UV) LED illuminating a phosphor that absorbs and converts UV light to red, green, and blue light.

Advantages of white light PC-LEDs over direct emission white LEDs include better color stability as a function of device aging and temperature, and better batch-to-batch and device-to-device color uniformity/repeatability. However, PC-LEDs can be less efficient than direct emission LEDs, due in part to inefficiencies in the process of light absorption and re-emission by the phosphor. For example, all LED phosphors currently used in commercial products have a refractive index greater than that of the encapsulants (epoxy or silicone). The mismatching of refractive index leads to light scattering and decreasing in overall device efficiency. It is estimated that reducing this light scattering can improve the efficiency of the LEDs by up to 20% (depending on design).

A well-known approach to reduce the scattering losses is using nanosized phosphors, for example, YAG or quantum dot phosphors such as CdSe. However, a side effect of this approach is that the nanosized phosphor has increased reactivity and sensitivity to encapsulant type and water; and the phosphor processing such as washing and filtering becomes difficult.

Advantageously, the present invention provides a method of adjusting the refractive index of a phosphor, and an optoelectronic device where the phosphor and the encapsulant have matching refractive index. The phosphor used in the optoelectronic device is chemically stable and optically comparable with the encapsulant. As such, the optoelectronic device can earn many technical merits such as increased light output efficiency, easy manufacturability, and cost-effectiveness, among others.

### BRIEF DESCRIPTION OF THE INVENTION

One aspect of the present exemplary embodiment is to provide an optoelectronic device comprising a light source, an encapsulant with refractive index n₁, and a phosphor with refractive index n₂ which is within the range of from about 0.85n₁ to about 1.15n₁.

Another aspect of the present exemplary embodiment is to provide a method of preparing an optoelectronic device, which comprises (i) providing a light source, and (ii) encapsulating the light source with an encapsulant with refractive index n₁ combined with a phosphor with refractive index n₂ which is within the range of from about 0.9n₁ to about 1.1n₁.

Still another aspect of the present exemplary embodiment is to provide a method of adjusting the refractive index of a phosphor nₓ which is more than 1.1 times higher than a predetermined value of the refractive index of an encapsulant, n₁. The method comprises (i) partially or completely replacing one or more first element(s) in the phosphor with one or more second element(s); and (ii) adjusting refractive index of the phosphor from nₓ to from about 0.9n₁ to about 1.1n₁.

### BRIEF DESCRIPTION OF THE DRAWINGS

FIG. 1 shows a schematic diagram of a LED device according to an embodiment of the present invention;

FIG. 2 shows a schematic diagram of a LED array on a substrate according to one embodiment of the present invention;

FIG. 3 shows a schematic diagram of a LED device according to another embodiment of the present invention; and

FIG. 4 shows a schematic diagram of a vertical cavity surface emitting laser device according to still another embodiment of the present invention.

### DETAILED DESCRIPTION OF THE INVENTION

The term refraction is defined herein as the bending of light as it passes between materials of different optical density. The term Refractive Index (n) of a material is defined as the ratio of the speed of light in vacuum (c) to the speed of light in that material (v).

It is to be understood herein, that if a “range” or “group” is mentioned with respect to a particular characteristic of the present disclosure, for example, percentage, chemical species, and temperature etc., it relates to and explicitly incorporates herein each and every specific member and combination of sub-ranges or sub-groups therein whatsoever. Thus, any specified range or group is to be understood as a shorthand way of referring to each and every member of a range or group individually as well as each and every possible sub-range or sub-group encompassed therein; and similarly with respect to any sub-ranges or sub-groups therein.

The present invention provides an optoelectronic device that comprises a light source, an encapsulant with refractive index n₁, and a phosphor with refractive index n₂. Generally, n₂ is within the range of from about 0.85n₁ to about 1.15n₁. Specifically, n₂ can be within the range of from about 0.90n₁ to about 1.10n₁. More specifically, n₂ can be within the range of from about 0.92n₁, to about 1.08n₁. Most specifically, n₂ can be within the range of from about 0.95n₁ to about 1.05n₁. Generally, n₁ is within the range of from about 1.3 to about 1.7. Specifically, n₁ is within the range of from about 1.5 to about 1.7; and more specifically, n₁ is within the range of from about 1.6 to about 1.7.

The present invention further provides a method of preparing an optoelectronic device, which comprises (i) providing a light source, and (ii) encapsulating the light source with an encapsulant with refractive index n₁ combined with a phosphor with refractive index n₂. Generally, n₂ is within the range of from about 0.85n₁ to about 1.15n₁. Specifically, n₂ can be within the range of from about 0.90n₁ to about 1.10n₁. More specifically, n₂ can be within the range of from about 0.92n₁ to about 1.08n₁. Most specifically, n₂ can be within the range of from about 0.95n₁ to about 1.05n₁, such as from about 0.98n₁ to about 1.02n₁. Generally, n₁ is within the range of from about 1.3 to about 1.7. Specifically, n₁ is within the range of from about 1.5 to about 1.7; and more specifically, n₁ is within the range of from about 1.6 to about 1.7.

The present invention also provides a method of adjusting the refractive Index of a phosphor nₓ which is more than 1.1 times higher than a predetermined value of the refractive index of an encapsulant, n₁. The method comprises (i) partially or completely replacing one or more first element(s) in the phosphor with one or more second element(s); and (ii) adjusting refractive index of the phosphor from nₓ to n₂. For example, the method may comprise (i) partially or completely replacing a first element in the phosphor with a second element having lower atomic weight than the first element; and (ii) adjusting refractive Index of the phosphor from nₓ to from about 0.9n₁ to about 1.1n₁.

In various embodiments, n₂ is within the range of from about 1.3 to about 1.7. Specifically, n₂ is within the range of from about 1.5 to about 1.7; and more specifically, n₂ is within the range of from about 1.6 to about 1.7.

In an embodiment, the present invention can provide LED phosphors with refractive index matching that of the LED encapsulant material, such as suitable epoxy resin, silicone, polycarbonate, polyvinyl chloride, polyetherimide, or any combination thereof. The refractive index matching may be achieved by varying the ratio of a heavier element (the first element) to a lighter element (the second element) in the host lattice of the phosphor.

Although any heavier element(s) in the phosphor may be partially or completely replaced with any suitable lighter element(s), typically the heavier element and the lighter element are in the same Group of the Periodic Table. For example, a phosphor may comprise an element in the alkaline earth metal group such as beryllium (Be) with an atomic weight of about 9, magnesium (Mg) with an atomic weight of about 24, calcium (Ca) with an atomic weight of about 40, strontium (Sr) with an atomic weight of about 88, barium (Ba) with atomic weight of about 137, or any mixture thereof. According to the invention, Mg may be partially or completely replaced with Be in the phosphor; Ca may be partially or completely replaced with Mg, Be, or any combination thereof; Sr may be partially or completely replaced with Ca, Mg, Be, or any combination thereof; and Ba may be partially or completely replaced with Sr Ca, Mg, Be, or any combination thereof. In a preferred embodiment, Ca is partially or completely replaced with Mg. In another preferred embodiment, Sr is partially or completely replaced with Ca.

In an embodiment, a phosphor may comprise an element in the halogen group such as fluorine (F) with an atomic weight of about 19, chlorine (Cl) with an atomic weight of about 35, bromine (Br) with an atomic weight of about 80, iodine (I) with an atomic weight of about 127, or any mixture thereof. According to the invention, Cl may be partially or completely replaced with F in the phosphor; Br may be partially or completely replaced with Cl, F, or any combination thereof; and I may be partially or completely replaced with Br, Cl, F, or any combination thereof. In a preferred embodiment, Cl is partially or completely replaced with F.

In an embodiment, a phosphor may comprise an element in the alkali metal group such as lithium (Li) with an atomic weight of about 7, sodium (Na) with an atomic weight of about 23, potassium (K) with an atomic weight of about 39, rubidium (Rb) with an atomic weight of about 85, cesium (Cs) with an atomic weight of about 133, or any mixture thereof. According to the invention, Na may be partially or completely replaced with Li in the phosphor; K may be partially or completely replaced with Li, Na, or any combination thereof; Rb may be partially or completely replaced with Li, Na, K, or any combination thereof; and Cs may be partially or completely replaced with Li, Na, K, Rb, or any combination thereof.

In an embodiment, Group 3 element in a phosphor such as scandium (Sc) with an atomic weight of about 45 may be used to replace any suitable trivalent element with an atomic weight greater than 45, such as Y, La, Ce, Pr, Nd, Sm, Eu, Gd, Tb, Dy, Ho, Er, Tm, Yb and/or Lu. In a preferred embodiment, the suitable trivalent element(s) with an atomic weight greater than 45 may be host lattice constituent(s) of a garnet phosphor, e.g. cerium activated yttrium aluminum garnet (YAG:Ce), cerium activated terbium aluminum garnet (TAG:Ce), and the like.

In an embodiment, Group 14 element in a phosphor such as silicon (Si) with an atomic weight of about 28 may be used to replace any suitable tetravalent element with an atomic weight greater than 28, such as Ge or Sn.

In preferred embodiments, when heavier element(s) in the phosphor is partially or completely replaced with lighter element(s), the particular host lattice of the phosphor remains unchanged, or the phosphor still has substantially the same crystallographic structure.

Examples of phosphors that may be subject to the method of refractive index adjustment include, but are not limited to, cerium activated garnet phosphors, divalent europium activated alkaline earth metal silicate phosphors, rare earth activated alkaline earth metal fluorohalide phosphors; divalent europium activated alkaline earth metal fluorohalide phosphors; rare earth element activated oxyhalide phosphors; cerium activated trivalent metal oxyhalide phosphors; bismuth activated alkaline metal halide phosphors; divalent europium activated alkaline earth metal halophosphate phosphors; divalent europium activated alkaline earth metal haloborate phosphors; divalent europium activated alkaline earth metal hydrogenated halide phosphors; cerium activated rare earth complex halide phosphors; cerium activated rare earth halophosphate phosphors; divalent europium activated cesium rubidium halide phosphors; divalent europium activated cerium halide rubidium phosphors; divalent europium activated composite halide phosphors; and tetravalent manganese activated alkaline earth metal fluorogermanate phosphors.

In an embodiment, the phosphor may comprise a europium and manganese doped alkaline earth pyrophosphate phosphor, for example, Sr₂P₂O₇:Eu²⁺,Mn²⁺, Ca₂P₂O₇:Eu²⁺,Mn²⁺, Mg₂P₂O₇:Eu²⁺,Mn²⁺, Be₂P₂O₇:Eu²⁺,Mn²⁺, or any mixture thereof. The phosphors may be represented as (Sr_{1-x-y}EuₓMn_{y})P₂O₇, (Ca_{1-x-y}EuₓMn_{y})P₂O₇, (Mg_{1-x-y}EuₓMn_{y})P₂O₇, (Be_{1-x-y}EuₓMn_{y})P₂O₇, or any mixture thereof, wherein 0<x≦0.2 and 0<y≦0.2.

When the refractive index of Ca₂P₂O₇:Eu²⁺,Mn²⁺ is to be adjusted, Mg may be used to completely or partially replace Ca. The product will have a formula such as (MgₙCa₁₋ₙ)₂P₂O₇:Eu²⁺,Mn²⁺, wherein 0<x≦1.

In the Eu²⁺ and Mn²⁺ doped alkaline earth pyrophosphate phosphor, the Eu ions generally act as sensitizers and Mn ions generally act as activators. Thus, the Eu ions absorb the incident energy (i.e., photons) and transfer the absorbed energy to the Mn ions. The Mn ions are promoted to an excited state by the absorbed transferred energy and emit a broad radiation band having a peak wavelength that varies from about 575 to 620 nm.

The method of adjusting the Refractive Index of a phosphor may be accomplished during the process of manufacturing the targeted phosphor. A phosphor may be made, for example, by any ceramic powder method, such as a wet chemical method or a solid state method.

In an embodiment, europium and manganese doped strontium pyrophosphate phosphor may be prepared according to the following step. First, the starting compounds are manually blended or mixed in a crucible or mechanically blended or mixed in another suitable container, such as a ball mill, to form a starting powder mixture. The starting compounds may comprise any oxide, phosphate, hydroxide, oxalate, carbonate and/or nitrate starting phosphor compound. The preferred starting phosphor compounds comprise strontium hydrogen phosphate, SrHPO₄, manganese carbonate MnCO₃, europium oxide, Eu₂O₃, and ammonium hydrogen phosphate (NH₄)HPO₄ powders. The (NH₄)HPO₄ powder may be added in an amount 2% in excess of its targeted stoichiometric ratio. A small excess of the Sr compound may also be added if desired. Under the present invention, calcium, barium and magnesium starting compounds may be added to substitute some or all of the strontium with calcium, barium and/or magnesium. The starting powder mixture may then be heated in air for about 1-5 hours at about 300 to 800° C., preferably at 600° C. The resulting powder may then be re-blended and subsequently fired in a reducing atmosphere at about 1000 to 1250° C., preferably 1000° C., to form a calcined phosphor body or cake. Preferably the starting powder mixture is calcined in a furnace in an atmosphere comprising nitrogen and 0.1 to 10% hydrogen for about four to ten hours, preferably about eight hours, and subsequently cooled in the same atmosphere by turning off the furnace.

In an embodiment, the phosphor may be a divalent europium activated alkaline earth silicate phosphor, ASIO:Eu²⁺, where A comprises at least one of Ba, Ca, Sr or Mg. The ratio between Ba, Ca, Sr or Mg may be so adjusted according to the present invention, to produce a phosphor product with desirable refractive index. For example, A may comprise at least 30% Ca, 60% or less Sr, and the balance Ba.

In the alkaline earth silicate phosphor, the europium activator substitutes on the alkaline earth lattice site. Other lighter dopants or impurities may be contained in the alkaline earth silicate phosphor. For example, the phosphor may contain an amount of fluorine incorporated during powder processing from a fluorine-containing flux compound, such as CaF₂ or EuF₃, and partially substituting the oxygen in its host lattice. This may adjust further the refractive index of the phosphor.

An exemplary method of making (Ca,Sr,Ba)₂SiO₄:Eu²⁺ phosphor comprises the following steps. First, the starting compounds of the phosphor may be manually blended or mixed in a crucible or mechanically blended or mixed in another suitable container, such as a ball mill, to form a starting powder mixture. The starting compounds may comprise any oxide, hydroxide, oxalate, carbonate and/or nitrate starting phosphor compound. The preferred starting phosphor compounds comprise calcium carbonate CaCO₃, strontium carbonate SrCO₃, barium carbonate BaCO₃, europium oxide, Eu₂O₃, and silicic acid, SiO₂.xH₂O. Preferably, a flux, such as NH₄Cl is added to the starting materials in an amount of 0.5 to 3 mole percent per mole of the phosphor produced. The starting powder mixture may then be fired in a reducing atmosphere, such as an atmosphere comprising nitrogen and 0.1 to 10% hydrogen at about 1100 to 1400° C. for 5 to 10 hours, to form a calcined phosphor body or cake.

Solid calcined phosphor bodies may be converted to phosphor powder in order to easily coat the phosphor powder on a portion of optoelectronic device. The solid phosphor body may be converted to phosphor powder by any crushing, milling or pulverizing method, such as wet milling, dry milling, jet milling or crushing. Preferably, the solid body is wet milled in propanol, methanol and/or water, and subsequently dried.

The phosphor may also comprises a divalent europium activated alkaline earth aluminate phosphor, AAIO:Eu²⁺, where A comprises at least one of Ba, Sr, Ca or mixture thereof. The ratio between these elements of different atomic weight may be so adjusted according to the present invention, to produce a phosphor product with desirable refractive index.

Other europium activated alkaline earth silicate phosphors are described in detail in G. Blasse et al., “Fluorescence of Eu²⁺ Activated Silicates” 23 Philips Res. Repts. 189-200 (1968), incorporated herein by reference. The europium activated alkaline earth aluminates phosphors are described in detail in G. Blasse et al., “Fluorescence of Eu²⁺ Activated Alkaline-Earth Aluminates” 23 Philips Res. Repts. 201-206 (1968), incorporated herein by reference.

In an embodiment, the phosphor may comprise a divalent europium activated halophosphate phosphor, DPOCl:Eu²⁺, where D comprises at least one of Sr, Ba, Ca, Mg, or any mixture thereof. The DPOCl:Eu²⁺ phosphor may comprise the commercially available “SECA” phosphor, D₅(PO₄)₃Cl:Eu²⁺. In addition to adjusting the ratio between Sr, Ba, Ca, and Mg, Cl may be partially or completely replaced with F to lower the refractive index of the phosphor. Optionally, a small amount of phosphate may be replaced by a small amount of borate to increase the emission intensity.

Other phosphor examples may comprise a divalent europium activated alkaline earth metal aluminate phosphor, AMgAlO:Eu²⁺, where A comprises at least one of Ba, Ca, Sr, or any mixture thereof. The aluminate phosphor may have various magnesium, aluminum and oxygen molar ratios and is commercially available under the name “BAM”. Other examples comprise divalent europium activated aluminate phosphors such as EO•AIO:Eu phosphor, EAIO:Eu²⁺ phosphor and/or a GAIO:Eu²⁺ phosphor, where E comprises at least one of Ba, Sr or Ca ions and G comprises at least one of K, Li, Na or Rb ions. According to the invention, the ratio between Ba, Sr and Ca, and the ratio between K, Li, Na and Rb ions may be so adjusted, to produce a phosphor product with desirable refractive index. The EO•AIO, EAIO and GAIO phosphors are described in the following references, each incorporated herein by reference in their entirety: A. L. N. Stevels and A. D. M. Schrama-de Pauw, Journal of the Electrochemical Society, 123 (1976) 691; J. M. P. J. Verstegen, Journal of the Electrochemical Society, 121 (1974) 1623; and C. R. Ronda and B. M. J. Smets, Journal of the Electrochemical Society, 136 (1989) 570.

In an embodiment, the method of the invention may be used to modify pre-existing phosphor preparative procedure. For example, the synthesis of BAM and SECA phosphors is described on pages 398-399 and 416-419 of S. Shionoya et al., Phosphor Handbook, CRC Press (1987, 1999), incorporated herein by reference. In general, a method of making a commercial BAM phosphor involves blending starting materials comprising barium carbonate, magnesium carbonate, alumina or aluminum hydroxide, europium oxide and optionally a flux, such as aluminum fluoride or barium chloride. The starting powder mixture is then fired in a reducing atmosphere at about 1200 to 1400° C. to form a calcined phosphor body or cake. The cake may be reground and refired under the same conditions. A method of making a commercial SECA phosphor involves blending starting materials comprising strontium carbonate, strontium orthophosphate, strontium chloride and europium oxide. The starting powder mixture may then be fired in a reducing atmosphere at about 1000 to 1200° C. to form a calcined phosphor body or cake. The cake is then ground into a phosphor powder.

In an embodiment, phosphor particles may be prepared from larger pieces of phosphor material by any grinding or pulverization method, such as ball milling using zirconia-toughened balls or jet milling. In other embodiments, phosphor particles may also be prepared by crystal growth from solution, and their size may be controlled by terminating the crystal growth at an appropriate time.

Specific examples of phosphors that are efficiently excited by radiation of 300 nm to about 500 nm include yellow-emitting phosphors such as YAG:Ce³⁺, TAG:Ce³⁺, (Ca,Sr,Ba)SiO₄:Eu²⁺, (Ba,Ca,Sr) (PO₄)₁₀(Cl,F)₂:Eu²⁺, Mn²⁺, green-emitting phosphors such as Ca₈Mg(SiO₄)₄Cl₂:Eu²⁺, Mn²⁺; GdBO₃:Ce³⁺,Tb²⁺; CeMgAl₁₁O₁₉:Tb³⁺; Y₂SiO₅:Ce³⁺, Tb³⁺; and BaMg₂Al₁₆O₂₇:Eu²⁺, Mn²⁺ etc.; red-emitting phosphors such as Y₂O₃:Bi³⁺,Eu³⁺; Sr₂P₂O₇:Eu²⁺,Mn²⁺; SrMgP₂O₇:Eu²⁺,Mn²⁺; (Y,Gd)(V,B)O₄:Eu³⁺; and 3.5 MgO0.5 MgF₂.GeO₂:Mn⁴⁺ (magnesium fluorogermanate) etc.; and blue-emitting phosphors such as BaMg₂Al₁₆O₂₇:Eu²⁺; Sr₅(PO₄)₁₀Cl₂:Eu²⁺; (Ba,Ca,Sr)(PO₄)₁₀(Cl,F)₂:Eu²⁺; and (Ca,Ba,Sr)(Al,Ga)₂S₄:Eu²⁺ etc.

Many phosphors such as halophosphate phosphors typically have a refractive index of about 1.7˜1.8, while the highest refractive index of epoxy resin is about 1.5˜1.7, such as about 1.6˜1.7. In an embodiment of the invention, such halophosphate phosphors may be modified to have a refractive index matching that of the epoxy resin. For example, a LED phosphor with the formula (Mg,Ca,Eu,Mn)₅(PO₄)₃(F,Cl) may be produced with a refractive index of about 1.60˜1.63, through adjustment of the Mg/Ca ratio, adjustment of the F/Cl ratio, lowering Eu concentration, or any combination thereof.

With no necessity of changing the phosphor size or coating the phosphor, the present invention redesigns the phosphor itself to match the refractive index of the encapsulant regardless of phosphor particle size. In an embodiment, when the refractive index of the phosphor matches that of the encapsulant material, the phosphor particles can visually “disappear” in the encapsulant and practically eliminate the light scattering losses.

Substitution of lighter for heavier elements generally tends to decrease the refractive index. It is believed that the index of refraction depends on the polarizability of the compound. Heavier elements have more electrons and tend to be more polarizable. Elements with lower atomic number have fewer electrons and so tend to be less polarizable. The index of refraction increases with increasing polarizability of the atoms. Therefore, one can alter the refractive index by changing the ratio of certain elements in a phosphor host lattice.

In preferred embodiments, the reflectance at phosphor/encapsulant surface, defined as [(n₁−n₂)/(n₁+ n₂)] is preferably less than 0.2%, and more preferably less than 0.1%. With very little reflectance at phosphor-encapsulant interface, little light will be trapped within the phosphor, and little light will be scattered by the phosphor particles. Also the light which is refracted or scattered will be primarily scattered in the forward direction out from the encapsulant package.

Suitable encapsulants, such as polyimides, epoxies, silicones and polyurethanes can be found with refractive indices as high as 1.62-1.63. However, these materials typically have aromatic rings which tend to absorb blue and near UV radiation from the chip and degrade with time. Stable polymers suitable as encapsulants generally have only aliphatic organic groups and have refractive indices in the range of 1.45-1.53. In order to have the low reflectance values mentioned above, the refractive index of the phosphor is preferably within 8-9% of that of the encapsulant and most preferably within 5-6%.

By using an element typically above the element commonly used in the periodic table, one can generally lower the phosphor refraction index, making it closer to that of a good encapsulant.

The present invention can provide numerous technical benefits in industrial applications. For example, the phosphor products are chemically stable and highly processable in the manufacturing of optoelectronic devices. Since the phosphors of the invention have minimal or no scattering loss for the light output, efficiency of optoelectronic device such as LED may be significantly improved. In an embodiment, reducing or eliminating the undesirable light scattering can improve the efficiency of the LEDs by up to 20%, depending on the specific design of the LEDs. The LED products manufactured according to the invention can be used, for example, as white and colored LEDs for transportation, signage and general illumination applications.

As described supra, the present invention provides an optoelectronic device that comprises a light source, an encapsulant with refractive Index n₁, and a phosphor with refractive Index n₂. Generally, n₂ is within the range of from about 0.85n₁ to about 1.15n₁. Specifically, n₂ can be within the range of from about 0.90n₁ to about 1.10n₁; and more specifically, n₂ can be within the range of from about 0.92n₁ to about 1.08n₁.

In an embodiment, the light source may be a light emitting diode (LED) or a laser diode; and the encapsulant may be any suitable epoxy resin, silicone, polycarbonate, polyvinyl chloride, polyetherimide, or any combination thereof.

Optionally, the encapsulant may be combined with one or more refractive index modifiers to further narrow the gap between the encapsulant's refractive index and the phosphor's refractive index. Non-limiting examples of suitable refractive index modifiers are compounds of Groups II, III, IV, V, and VI of the Periodic Table. Non-limiting examples are titanium oxide, hafnium oxide, aluminum oxide, gallium oxide, indium oxide, yttrium oxide, zirconium oxide, cerium oxide, lead oxide, or gallium nitride.

Optoelectronic device of the invention may be any solid-state and other electronic device for generating, modulating, transmitting, and sensing electromagnetic radiation in the ultraviolet, visible, and infrared portions of the spectrum. Optoelectronic devices, sometimes referred to as semiconductor devices or solid state devices, include, but are not limited to, light emitting diodes (LEDs), charge coupled-LED devices (CCDs), photodiodes, vertical cavity surface emitting lasers (VCSELs), phototransistors, photocouplers, opto-electronic couplers, and the like. However, it should be understood that the encapsulant formulation can also be used in devices other than an optoelectronic device, for example, logic and memory devices, such as microprocessors, ASICs, DRAMs and SRAMs, as well as electronic components, such as capacitors, inductors and resistors, among others.

Several non-limiting examples of optoelectronic devices of the present invention are illustrated in the accompanying drawings. These figures are merely schematic representations based on convenience and the ease of demonstrating, and are, therefore, not intended to indicate relative size and dimensions of the optoelectronic devices or components thereof.

Although specific terms are used in the following description for the sake of clarity, these terms are intended to refer only to the particular structure of the embodiments selected for illustration in the drawings, and are not intended to define or limit the scope of the invention. In the drawings and the following description below, it is to be understood that like numeric designations refer to component of like function.

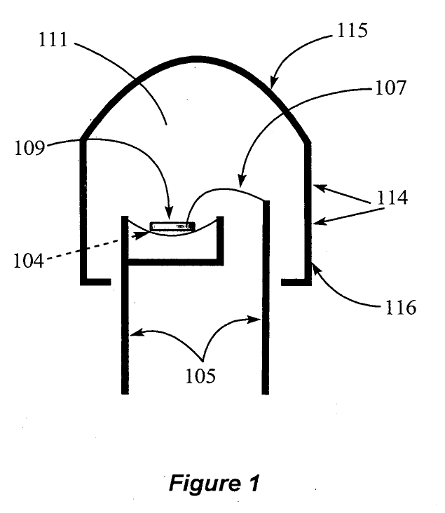

With reference to FIG. 1, a device according to one embodiment of the present invention is schematically illustrated. The device contains a LED chip 104, which is electrically connected to a lead frame 105. For example, the LED chip 104 may be directly electrically connected to an anode or cathode electrode of the lead frame 105 and connected by a lead 107 to the opposite cathode or anode electrode of the lead frame 105, as illustrated in FIG. 1. In a particular embodiment illustrated in FIG. 1, the lead frame 105 supports the LED chip 104. However, the lead 107 may be omitted, and the LED chip 104 may straddle both electrodes of the lead frame 105 with the bottom of the LED chip 104 containing contact layers, which contact both the anode and cathode electrode of the lead frame 105. The lead frame 105 connects to a power supply, such as a current or voltage source or to another circuit (not shown).

The LED chip 104 emits radiation from the radiation emitting surface 109. The LED may emit visible, ultraviolet or infrared radiation. The LED chip 104 may be any LED chip containing a p-n junction of any semiconductor layers capable of emitting the desired radiation. For example, the LED chip 104 may contain any desired Group III-V compound semiconductor layers, such as GaAs, GaAlAs, GaN, InGaN, GaP, etc., or Group II-VI compound semiconductor layers such as ZnO, ZnSe, ZnSSe, CdTe, etc., or Group IV-IV semiconductor layers, such as SiC. The LED chip 104 may also contain other layers, such as cladding layers, waveguide layers and contact layers.

The LED is packaged with an encapsulant 111 prepared according to the present invention. In one embodiment, the encapsulant 111 is used with a shell 114. The shell 114 may be any plastic or other material, such as polycarbonate, which is transparent to the LED radiation. However, the shell 114 may be omitted to simplify processing if encapsulant 111 has sufficient toughness and rigidity to be used without a shell. Thus, the outer surface of encapsulant 111 would act in some embodiments as a shell 114 or package. The shell 114 contains a light or radiation emitting surface 115 above the LED chip 104 and a non-emitting surface 116 adjacent to the lead frame 105. The radiation emitting surface 115 may be curved to act as a lens and/or may be colored to act as a filter. In various embodiments the non-emitting surface 116 may be opaque to the LED radiation, and may be made of opaque materials such as metal. The shell 114 may also contain a reflector around the LED chip 104, or other components, such as resistors, etc., if desired.

According to the present invention, the phosphor with encapsulant-matching refractive index may be coated as a thin film on the LED chip 104; or coated on the inner surface of the shell 114; or interspersed or mixed as a phosphor powder with encapsulant 111. Any suitable phosphor material according to this invention may be used with the LED chip.

While the packaged LED chip 104 is supported by the lead frame 105 according to one embodiment as illustrated in FIG. 1, the device can have various other structures. For example, the LED chip 104 may be supported by the bottom surface 116 of the shell 114 or by a pedestal (not shown) located on the bottom of the shell 114 instead of by the lead frame 105.

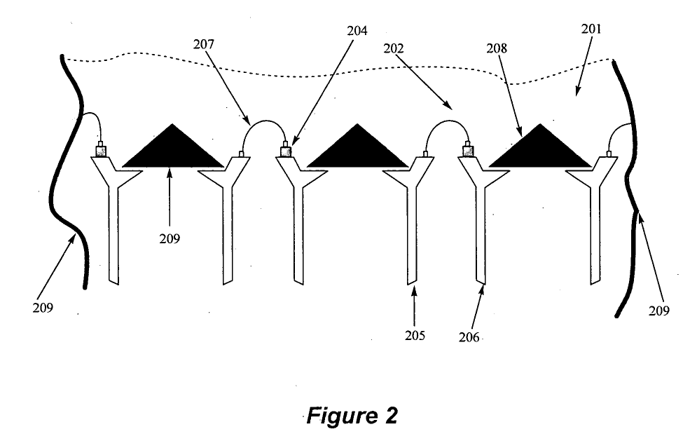

With reference to FIG. 2, a device including a LED array fabricated on a plastic substrate is illustrated. LED chips or dies 204 are physically and electrically mounted on cathode leads 206. The top surfaces of the LED chips 204 are electrically connected to anode leads 205 with lead wires 207. The lead wires may be attached by known wire bonding techniques to a conductive chip pad. The leads 206, 205 comprise a lead frame and may be made of a metal, such as silver plated copper. The lead frame and LED chip array are contained in a plastic package 209, such as, for example, a polycarbonate package, a polyvinyl chloride package or a polyetherimide package. In some embodiments, the polycarbonate comprises a bisphenol A polycarbonate. The plastic package 209 is filled with an encapsulant 201 and phosphor with encapsulant-matching refractive index (not shown) according to the present invention. The package 209 contains tapered interior sidewalls 208, which enclose the LED chips 204, and form a light spreading cavity 202, which ensures cross fluxing of LED light.

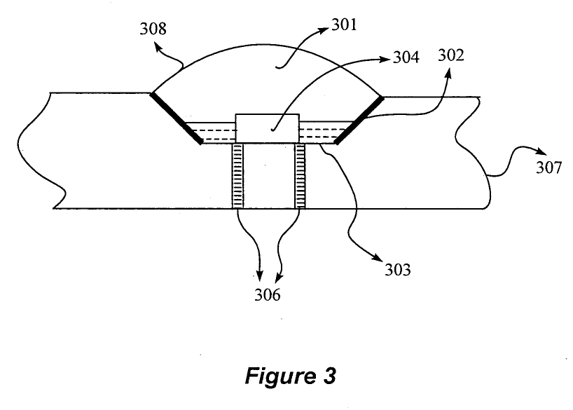

FIG. 3 shows a device wherein the LED chip 304 is supported by a carrier substrate 307. With reference to FIG. 3, the carrier substrate 307 comprises a lower portion of the LED package, and may comprise any material, such as plastic, metal or ceramic. Preferably, the carrier substrate is made out of plastic and contains a groove 303 wherein the LED chip 304 is located. The sides of the groove 303 may be coated with a reflective metal 302, such as aluminum, which acts as a reflector. However, the LED chip 304 may be formed over a flat surface of the substrate 307 as well. The substrate 307 contains electrodes 306 that electrically contact the contact layers of the LED chip 304. Alternatively, the electrodes 306 may be electrically connected to the LED chip 304 with one or two leads as illustrated in FIG. 3. The LED chip 304 is covered with an encapsulant 301 and a phosphor with encapsulant-matching refractive index (not shown) according to the present invention. If desired, a shell 308 or a glass plate may be formed over the encapsulant 301 to act as a lens or protective material.

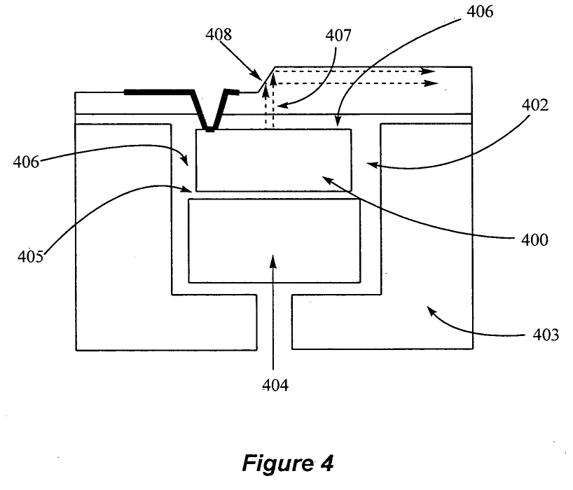

A vertical cavity surface emitting laser (VCSEL) is illustrated in FIG. 4. With reference to FIG. 4, a VCSEL 400 may be embedded inside a pocket 402 of a printed circuit board assembly 403. A heat sink 404 may be placed in the pocket 402 and the VCSEL 400 may rest on the heat sink 404. The encapsulant 406 may be formed by filling, such as injecting, an encapsulant formulation into the cavity 405 of the pocket 402 in the printed circuit board 403, which may flow around the VCSEL and encapsulate it on all sides and also form a coating top film 406 on the surface of the VCSEL 400. The top coating film 406 may protect the VCSEL 400 from damage and degradation and at the same time may also be inert to moisture, transparent and polishable. The laser beams 407 emitting from the VCSEL may strike the mirrors 408 to be reflected out of the pocket 402 of the printed circuit board 403.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and publications cited herein are incorporated herein by reference.

1. An optoelectronic device comprising a light source, an encapsulant with a refractive Index n₁, and a phosphor with a refractive Index n₂ which is within the range of from about 0.85n₁ to about 1.15n₁.

2. The optoelectronic device according to claim 1, wherein n₂ is within the range of from about 0.9n₁ to about 1.1n₁.

3. The optoelectronic device according to claim 1, wherein n₂ is within the range of from about 0.95n₁ to about 1.05n₁.

4. The optoelectronic device according to claim 1, wherein n₁ is about 1.5˜1.7.

5. The optoelectronic device according to claim 1, wherein the encapsulant comprises epoxy resin, silicone, polycarbonate, polyvinyl chloride, polyetherimide, or any combination thereof.

6. The optoelectronic device according to claim 1, wherein the encapsulant includes a refractive index modifier.

7. The optoelectronic device according to claim 1, wherein the light source is a light emitting diode (LED) or a laser diode.

8. A method of adjusting the refractive index nₓ of a phosphor that is more than 1.1 times higher than a refractive index of an encapsulant, n₁, which comprises (i) partially or completely replacing one or more first element(s) in the phosphor with one or more second element(s) having lower atomic weight than the first element; and (ii) adjusting a refractive index of the phosphor from nₓ to from about 0.85n₁ to about 1.15n₁.

9. The method according to claim 8, wherein the first element and at least one second element belong to the same group of the Periodic Table.

10. The method according to claim 9, wherein the group of the Periodic Table is selected from the alkaline earth metal group, the halogen group, or the alkali metal group.

11. The method according to claim 8, wherein the first element is Ba or Sr and the second element is Ca or Mg.

12. The method according to claim 8, wherein the first element is Cl and the second element is F.

13. The method according to claim 8, wherein the second element is scandium (Sc).

14. The method according to claim 8, wherein the phosphor is selected from cerium activated garnet phosphors, divalent europium activated alkaline earth metal silicate phosphors, rare earth activated alkaline earth metal fluorohalide phosphors; divalent europium activated alkaline earth metal fluorohalide phosphors; rare earth element activated oxyhalide phosphors; cerium activated trivalent metal oxyhalide phosphors; bismuth activated alkaline metal halide phosphors; divalent europium activated alkaline earth metal halophosphate phosphors; divalent europium activated alkaline earth metal haloborate phosphors; divalent europium activated alkaline earth metal hydrogenated halide phosphors; cerium activated rare earth complex halide phosphors; cerium activated rare earth halophosphate phosphors; divalent europium activated cesium rubidium halide phosphors; divalent europium activated cerium halide rubidium phosphors; and divalent europium activated composite halide phosphors.

15. The method according to claim 14, wherein the europium activated alkaline earth metal halophosphate phosphor has a formula of (Mg,Ca,Eu,Mn)₅(PO₄)₃(F,Cl), and n₁ is about 1.60˜1.63.

16. The method according to claim 15, wherein step (i) comprises one of adjusting the Mg/Ca ratio, adjusting the F/Cl ratio, or any combination thereof.

17. The method according to claim 14, wherein the europium activated alkaline earth metal silicate phosphor has a formula of (Ca,Sr,Ba)SiO₄:Eu²⁺.

18. The method according to claim 17, wherein the europium activated alkaline earth metal silicate phosphor further contains F partially substituting 0 in its host lattice.

19. A method of preparing an optoelectronic device, which comprises (i) providing a light source, and (ii) encapsulating the light source with an encapsulant with refractive index n₁ combined with a phosphor with refractive index n₂, wherein n₂ is within the range of from about 0.85n₁ to about 1.15n₁.

20. The method according to claim 19, wherein the light source comprises a light emitting diode (LED) or a laser diode.
